(19) United States
(12) Patent Application Publication
(10) Pub. No.: US 2020/0171718 A1
(43) Pub. Date: Jun. 4, 2020

(54) MULTILAYER HOLLOW MASSAGE AUXILIARY TOOL AND MANUFACTURING METHOD THEREOF

(71) Applicant: Heng-Sheng CHOU, Taoyuan City (TW)

(72) Inventor: Heng-Sheng CHOU, Taoyuan City (TW)

(21) Appl. No.: 16/688,983

(22) Filed: Nov. 19, 2019

(30) Foreign Application Priority Data
Nov. 30, 2018 (TW) 107142985

(51) Int. Cl. B29C 44/12; B29C 44/38; B29C 44/34; A61H 15/00

(52) U.S. Cl. CPC B29C 44/1242; B29C 44/1276; B29C 44/388; B29K 2027/06; A61H 15/0092; A61H 2015/0042; A61H 2015/0014; B29C 44/3415

(57) ABSTRACT

A multilayer hollow massage auxiliary tool and a manufacturing method thereof are disclosed. The manufacturing method includes steps of: disposing a first plastic material in a mold cavity; allowing the first plastic material to be melted and expanded for forming as a first gel layer; allowing a second plastic material to be disposed in the mold cavity; allowing the second plastic material to be disposed in the first gel layer and melted and expanded for forming as a second gel layer; allowing the first gel layer and the second gel layer to be gelled as one piece; and allowing the first gel layer to be solidified to form as an outer body and allowing the second gel layer to be solidified to form as an inner body.

### BACKGROUND OF THE INVENTION

### Field of the Invention

The present invention relates to a massage tool, especially to a multilayer hollow massage auxiliary tool and a manufacturing method thereof.

### Description of Related Art

People would use a massage ball to massage fascia or patting muscles when feeling muscle fatigue or tight fascia, so that effects of stretching or relaxing fascia or muscles can be achieved. Wherein, a surface of the massage ball is disposed with a soft plastic layer made of PU, PE, EVA or various kind of foaming materials for allowing the massage ball to be provided with a property of being comfortable while being in contact with skins.

However, the above-mentioned soft plastic layer is mostly fastened on the surface of the massage ball in means of adhering, latching or locking, the adhering means may cause the soft plastic layer of the massage ball to be separated from the massage ball, and the latching or locking means may cause a feeling of having a foreign object on the surface of the massage ball. Thus, how to enhance the structural stability of the soft plastic layer of the massage ball for improving the mentioned disadvantages is the issue to be solved by the applicant of the present invention.

Accordingly, the applicant of the present invention has devoted himself for improving the mentioned disadvantages.

### SUMMARY OF THE INVENTION

The present invention is to provide a multilayer hollow massage auxiliary tool and a manufacturing method thereof, in which a mold opening operation, a shaking operation and a heating operation are utilized for enabling an inner body to be directly melted and gelled for being formed on an inner surface of the outer body, so that the structural stability of the multilayer hollow massage auxiliary tool can be enhanced.

According to one embodiment of the present invention, a manufacturing method of a multilayer hollow massage auxiliary tool includes steps of: a) providing a mold, forming a mold cavity inside the mold, and disposing a first plastic material in the mold cavity, and engaging the mold; b) providing a shaking device and a heating device, processing a first shaking and melting and expanding operation to the mold for allowing the first plastic material to be comprehensively disposed on an inner wall of the mold cavity and melted and expanded so as to be formed as a first gel layer; c) processing a mold opening operation to the mold for allowing a second plastic material to be disposed in the mold cavity and engaging the mold, thereby enabling the second plastic material to be arranged in a space defined by the first gel layer; d) processing a second shaking and melting and expanding operation to the mold for allowing the second plastic material to be comprehensively disposed in the space defined by the first gel layer and melted and expanded so as to be formed as a second gel layer; e) processing a third shaking and melting operation to the mold for allowing the first gel layer and the second gel layer to be melted and gelled, meanwhile allowing an inner surface of the first gel layer and an outer surface of the second gel layer to be gelled for being formed as one piece; and f) processing a cooling operation to the mold for allowing the first gel layer to be solidified to form as an outer body and allowing the second gel layer to be solidified to form as an inner body, and the inner body being comprehensively formed on an inner surface of the outer body after being melted and gelled.

According to one embodiment of the present invention, a multilayer hollow massage auxiliary tool includes: an inner body; and an outer body, comprehensively disposed and formed on an outer surface of the inner body after being melted and gelled.

Based on what has been disclosed above, with the mold opening operation, the shaking operation and the heating operation, surfaces where the outer body and the inner body are in contact can be connected via being melted and gelled, so that the manufacturing method of the multilayer hollow massage auxiliary tool of the present invention is provided with advantages of simple in manufacturing procedure and stable in structure compared to the prior art of the inner layer and the outer layer of the conventional massage ball being connected in means of adhering, latching or locking.

### BRIEF DESCRIPTION OF DRAWING

FIG. 1 is a flowchart showing a manufacturing method of a multilayer hollow massage auxiliary tool according to one embodiment of the present invention;

FIG. 2 is a schematic view showing a first plastic material being disposed in a mold cavity according to one embodiment of the present invention;

FIG. 3 is a schematic view showing processing a first shaking and melting and expanding operation to a mold according to one embodiment of the present invention;

FIG. 4 is a schematic view showing a second plastic material being disposed in the mold cavity according to one embodiment of the present invention;

FIG. 5 is a schematic view showing processing a second shaking and melting and expanding operation to the mold according to one embodiment of the present invention;

FIG. 6 is a schematic view showing processing a third shaking and melting operation to the mold and processing a cooling operation according to one embodiment of the present invention;

FIG. 7 is a cross sectional view showing the multilayer hollow massage auxiliary tool according to one embodiment of the present invention; and

FIG. 8 is a schematic view showing the second plastic material being disposed in the mold cavity according to another embodiment of the present invention.

### DETAILED DESCRIPTION OF THE INVENTION

Preferred embodiments of the present invention will be described with reference to the drawings.

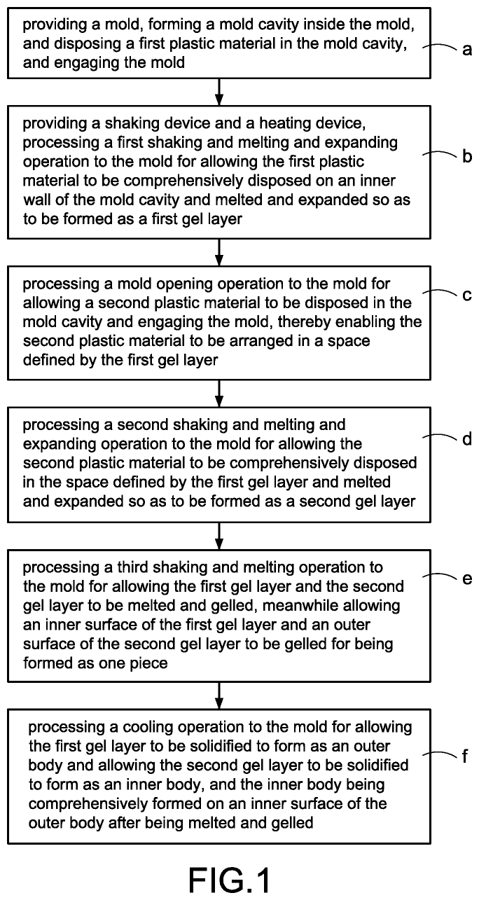

Please refer from FIG. 1 to FIG. 7; a multilayer hollow massage auxiliary tool and a manufacturing method are disclosed. The multilayer hollow massage auxiliary tool 10 includes an inner body 22 and an outer body 12.

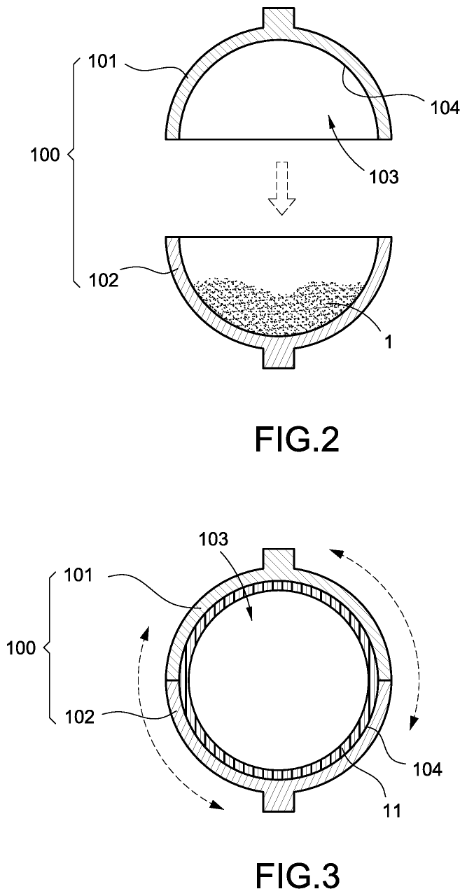

As shown in FIG. 1, the manufacturing method of multilayer hollow massage auxiliary tool are provided as follows. According to a step a) disclosed in FIG. 1 and as shown FIG. 2, a mold 100 is provided, a mold cavity 103 is formed inside the mold 100, a first plastic material 1 is disposed in the mold cavity 103, and then the mold 100 is engaged; wherein, according to this embodiment, the mold 100 is composed of a top mold piece 101 and a bottom mold piece 102 being mutually engaged, the first plastic material 1 is a paste-like soft polyvinyl chloride (PVC), but what shall be addressed is that the scope of the present invention is not limited to the above-mentioned paste-like soft polyvinyl chloride.

According to a step b) disclosed in FIG. 1 and as shown in FIG. 3, a shaking device and a heating device are provided, the mold 100 is processed with a first shaking and melting and expanding operation, so that the first plastic material 1 is comprehensively disposed on an inner wall 104 of the mold cavity 103 and is melted and expanded so as to be formed as a first gel layer 11; wherein, in the first shaking and melting and expanding operation, a heating temperature provided by the heating device to the mold 100 is between 130 to 150 degrees Celsius, so that the paste-like soft polyvinyl chloride is melted and expanded to be formed as the first gel layer 11 in a thicker status, and the shaking device is used for shaking the mold 100 with 360 degrees in directions upwards top, bottom, left, right, front and rear, thereby allowing the first gel layer 11 to be evenly disposed on a whole surface of the inner wall 104 of the mold cavity 103.

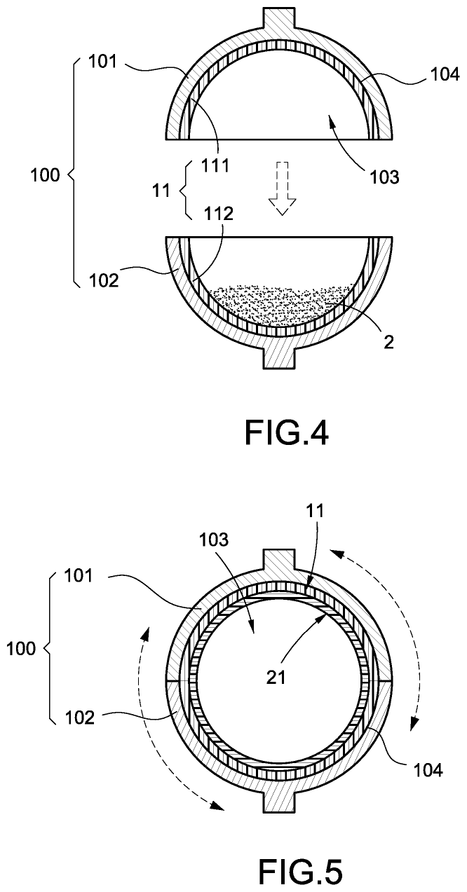

According to a step c) disclosed in FIG. 1 and as shown in FIG. 4, the mold 100 is processed with a mold opening operation, a second plastic material 2 is disposed in the mold cavity 103 and then the mold 100 is engaged, so that the second plastic material 2 is arranged in a space defined by the first gel layer 11; wherein, according to this embodiment, the molding opening operation is to separate the top mold piece 101 and the bottom mold piece 102, so that the first gel layer 11 is divided into a top gel layer 111 and a bottom gel layer 112 while the top mold piece 101 and the bottom mold piece 102 being separated, thereby allowing the second plastic material 2 to be disposed in the space defined by the first gel layer 11, wherein the second plastic material 2 is a paste-like hard polyvinyl chloride (PVC), but what shall be addressed is that the scope of the present invention is not limited to the above-mentioned paste-like hard polyvinyl chloride.

According to a step d) disclosed in FIG. 1 and as shown in FIG. 5, the mold 100 is processed with a second shaking and melting and expanding operation, so that the second plastic material 2 is comprehensively disposed on the first gel layer 11 and is melted and expanded so as to be formed as a second gel layer 21; wherein, in the second shaking and melting and expanding operation, a heating temperature provided by the heating device to the mold 100 is between 130 to 150 degrees Celsius, so that the paste-like hard polyvinyl chloride is melted and expanded to be formed as the second gel layer 21 in a thicker status, and the shaking device is used for shaking the mold 100 with 360 degrees in directions upwards top, bottom, left, right, front and rear, thereby allowing the second gel layer 21 to be evenly disposed on a whole surface defined at an inner side of the first gel layer 11.

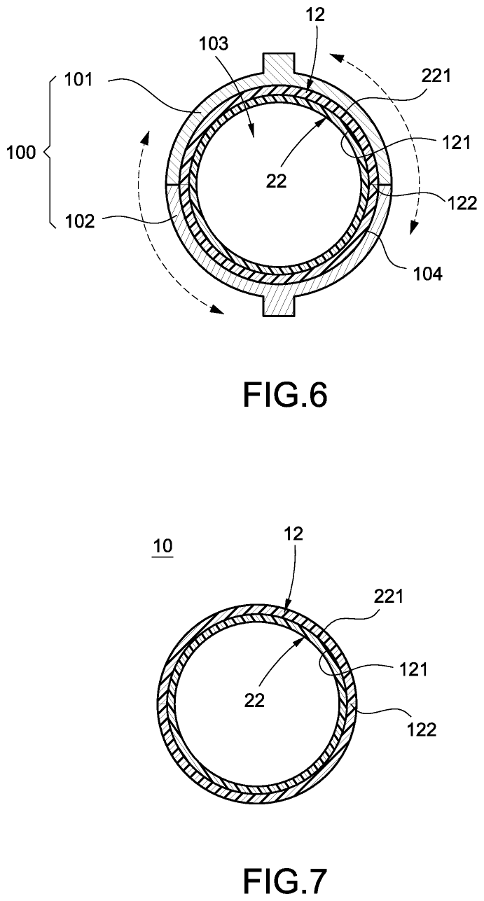

According to a step e) and a step f) disclosed in FIG. 1 and as shown in FIG. 5 and FIG. 6, the step e) is to process a third shaking and melting operation to the mold 100, so that the first gel layer 11 and the second gel layer 21 are melted and gelled, meanwhile an inner surface of the first gel layer 11 and an outer surface of the second gel layer 21 are gelled for being formed as one piece; the step f) is to process a cooling operation to the mold 100, so that the first gel layer 11 is solidified to form as the outer body 12, the second gel layer 21 is solidified to form as the inner body 22, and the inner body 22 is comprehensively formed on an inner surface 121 of the outer body 12 after being melted and gelled; wherein, in the third shaking and melting operation, a heating temperature provided by the heating device to the mold 100 is between 165 to 180 degrees Celsius, in other words the heating temperature of the third shaking and melting operation is higher than that of the first shaking and melting and expanding operation and that of the second shaking and melting and expanding operation, so that surfaces where the first gel layer 11 and the second gel layer 21 are in contact can be melted and mutually gelled for being formed as one piece; after the mold 100 has been cooled for a period of time, the first gel layer 11 is cooled and solidified to form as the outer body 12, the second gel layer 21 is cooled and solidified to form as the inner body 22, and the surfaces wherein the first gel layer 11 and the second gel layer 21 are in contact are melted and mutually gelled, thereby allowing the inner body 22 to be evenly disposed and connected to the whole surface of the inner surface of the outer body 12.

Moreover, please refer to FIG. 6 and FIG. 7, the mold 100 is processed with a mold removing operation, so that a finished product of the multilayer hollow massage auxiliary tool 10 can be obtained; according to this embodiment, the mold 100 is composed of the top mold piece 101 and the bottom mold piece 102 being mutually engaged, thus in the above-mentioned mold removing operation, the first gel layer 11 is divided into the top gel layer 111 and the bottom gel layer 112 while the top mold piece 101 and the bottom mold piece 102 are separated, then the second plastic material 2 is disposed in the space defined by the first gel layer 11, the mold 100 is engaged, and the outer body 12 can be comprehensively disposed and melted and gelled on an outer surface 221 of the inner body 22, and the outer body 12 is provided with an annular engaging slit 122 formed along an outer circumference thereof, the annular engaging slit 122 is formed through the top gel layer 111 and the bottom gel layer 112 being separated than connected via being melted and gelled. Wherein, the inner body 22 is made of the hard-polyvinyl chloride, and the outer body 12 is made of the soft polyvinyl chloride.

Wherein, the first plastic material 1 is soft plastic material, and not limited to the soft polyvinyl chloride; the second plastic material 2 is a hard plastic material, and not limited to the hard polyvinyl chloride, so that the outer body 12 is formed as a soft plastic body, the inner body 22 is formed as a hard plastic body, thereby allowing the multilayer hollow massage auxiliary tool 10 to be provided with properties of plasticity and comfortable in touch while being used.

Moreover, the multilayer hollow massage auxiliary tool 10 can be formed in various geometrical shapes, such as round shape, 8-like shape, oval shape or polygonal shape, but what shall be addressed is that the scope of the present invention is not limited to the above-mentioned shapes.

As shown from FIG. 1 to FIG. 7, the manufacturing method of the multilayer hollow massage auxiliary tool provided by the present invention is: the first plastic material 1 is disposed in the mold cavity 103 and processed with the first shaking and melting and expanding operation, so that the first plastic material 1 can be comprehensively disposed on the inner wall 104 of the mold cavity 103 and melted and expanded to be formed as the first gel layer 11, and the mold opening operation is processed to allow the second plastic material 2 to be disposed in the space defined by the first gel layer 11, after the second shaking and melting and expanding operation, the second plastic material 2 can be comprehensively disposed in the space defined by the first gel layer 11 and melted and expanded so as to be formed as the second gel layer 21, then the mold 100 is processed with the third shaking and melting operation for allowing the first gel layer 11 and the second gel layer 21 to be melted and mutually gelled, meanwhile the inner surface of the first gel layer 11 and the outer surface of the second gel layer 12 are melted and mutually gelled as one piece, lastly the mold 100 is processed with the cooling operation for allowing the first gel layer 11 to be solidified as the outer body 12 and allowing the second gel layer 21 to be solidified as the inner body 12, and the inner body 22 can be comprehensively disposed and melted so as to be formed on the inner surface 121 of the outer body 12. Accordingly, comparing to the prior art of the inner layer and the outer layer of the conventional massage ball being connected in means of adhering, latching or locking, the manufacturing method of the multilayer hollow massage auxiliary tool of the present invention is provided with advantages of simple in manufacturing procedure and stable in structure.

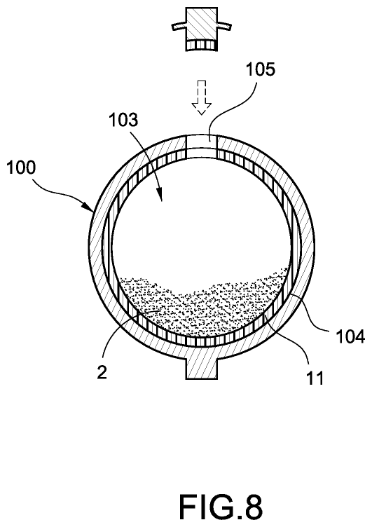

Please refer to FIG. 8, which discloses another embodiment of the second plastic material 2 being disposed in the mold cavity 103 according to the present invention, a difference between the embodiment disclosed from FIG. 2 to FIG. 7 and the another embodiment disclosed in FIG. 8 is the structure of the mold 100.

Details are provided as follows. According to the another embodiment, an operable pouring port 105 communicated with the mold cavity 103 is formed in the mold 100, the mold opening operation is to open the operable pouring port 105 for allowing the second plastic material 2 to be filled in the space defined by the first gel layer 11 via the operable pouring port 105. Accordingly, the same functions and effects provided by the embodiment disclosed from FIG. 2 to FIG. 7 can be achieved.

Moreover, comparing to the embodiment disclosed from FIG. 2 to FIG. 7, the outer body 12 of the finished product of the multilayer hollow massage auxiliary tool 10 of the another embodiment is not formed with the annular engaging slit 122 along the outer circumference thereof, in other words a surface of the outer body 12 manufactured by the mold 100 disclosed in the another embodiment is smooth and has no slit.

Based on what has been disclosed above, the multilayer hollow massage auxiliary tool and the manufacturing method thereof provided by the present invention are novel and more practical in use comparing to prior art.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A manufacturing method of a multilayer hollow massage auxiliary tool, including steps of:
a) providing a mold, forming a mold cavity inside the mold, disposing a first plastic material in the mold cavity, and engaging the mold;
b) providing a shaking device and a heating device, processing a first shaking and melting and expanding operation to the mold for allowing the first plastic material to be comprehensively disposed on an inner wall of the mold cavity and melted and expanded so as to be formed as a first gel layer;
c) processing a mold opening operation to the mold for allowing a second plastic material to be disposed in the mold cavity and engaging the mold, thereby enabling the second plastic material to be arranged in a space defined by the first gel layer;
d) processing a second shaking and melting and expanding operation to the mold for allowing the second plastic material to be comprehensively disposed in the space defined by the first gel layer and melted and expanded so as to be formed as a second gel layer;
e) processing a third shaking and melting operation to the mold for allowing the first gel layer and the second gel layer to be melted and gelled, meanwhile allowing an inner surface of the first gel layer and an outer surface of the second gel layer to be gelled for being formed as one piece; and
f) processing a cooling operation to the mold for allowing the first gel layer to be solidified to form as an outer body and allowing the second gel layer to be solidified to form as an inner body, and the inner body being comprehensively disposed and formed on an inner surface of the outer body after being melted and gelled.

2. The manufacturing method of the multilayer hollow massage auxiliary tool according to claim 1, wherein the mold is composed of a top mold piece and a bottom mold piece being mutually engaged, the molding opening operation is to separate the top mold piece and the bottom mold piece, so that the first gel layer is divided into a top gel layer and a bottom gel layer while the top mold piece and the bottom mold piece being separated.

3. The manufacturing method of the multilayer hollow massage auxiliary tool according to claim 1, wherein an operable pouring port communicated with the mold cavity is formed in the mold, the mold opening operation is to open the operable pouring port for allowing the second plastic material to be filled in the space defined by the first gel layer via the operable pouring port.

4. The manufacturing method of the multilayer hollow massage auxiliary tool according to claim 1, wherein the first plastic material is soft plastic material, and the second plastic material is a hard plastic material, so that the outer body is formed as a soft plastic body, and the inner body is formed as a hard plastic body.

5. The manufacturing method of the multilayer hollow massage auxiliary tool according to claim 4, wherein the first plastic material is a paste-like soft polyvinyl chloride, and the second plastic material is a paste-like hard polyvinyl chloride.

6. The manufacturing method of the multilayer hollow massage auxiliary tool according to claim 5, wherein a heating temperature of the third shaking and melting operation is higher than a heating temperature of the first shaking and melting and expanding operation and a heating temperature of the second shaking and melting and expanding operation.

7. The manufacturing method of the multilayer hollow massage auxiliary tool according to claim 6, wherein the heating temperature of the first shaking and melting and expanding operation and the heating temperature of the second shaking and melting and expanding operation are between 130 to 150 degrees Celsius, and the heating temperature of the third shaking and melting operation is between 165 to 180 degrees Celsius.

8. A multilayer hollow massage auxiliary tool, including:
an inner body; and
an outer body, comprehensively disposed and formed on an outer surface of the inner body after being melted and gelled.

9. The multilayer hollow massage auxiliary tool according to claim 8, wherein the outer body is provided with an annular engaging slit formed along an outer circumference thereof.

10. The multilayer hollow massage auxiliary tool according to claim 8, wherein the outer body is formed as a soft plastic body, and the inner body is formed as a hard plastic body.

11. The multilayer hollow massage auxiliary tool according to claim 10, wherein the inner body is made of a hard polyvinyl chloride, and the outer body is made of a soft polyvinyl chloride.
